(19) United States
(12) Patent Application Publication
(10) Pub. No.: US 2021/0061617 A1
(43) Pub. Date: Mar. 4, 2021

(54) Systems and Methods of Providing Vertically Adjustable Steps

(71) Applicant: Evermore Systems Inc., Austin, TX (US)

(72) Inventors: John Hancock Lupher, Austin, TX (US); Matthew J. Shultz, Manor, TX (US); Michael Lupher, Austin, TX (US); Abhijay Saini, Austin, TX (US)

(73) Assignee: Evermore Systems Inc., Austin, TX (US)

(21) Appl. No.: 16/560,561

(22) Filed: Sep. 4, 2019

(51) Int. Cl. B66B 23/12

(52) U.S. Cl. CPC B66B 23/12; B66B 21/00

(57) ABSTRACT

In some embodiments, a stairway system may include a staircase having a plurality of steps and including a plurality of actuators. Each step may be coupled to one or more actuators and may be configured to move vertically in coordination with one or more other steps to provide a virtual platform to carry a user from a first elevation to a second elevation as the user moves. A control system may cause the virtual platform to move continuously along the staircase by progressively adjusting a sequential set of steps to a common elevation, such that a user can walk forward across a level platform formed from two or more steps while the virtual platform changes elevation carrying the user.

### FIELD

The present disclosure is generally related to stairway lifts, and more specifically to vertically adjustable stairs configured to provide a virtual lift platform. In some implementations, a staircase system may provide a high-speed lifting movement via a moving virtual platform.

### BACKGROUND

Many homes have multiple floors. Household members may traverse a staircase multiple times per day. Stair lifts comprising a carriage configured to provide an ascending and descending function have been used to carry a person who has difficulty climbing up and down stairs on their own. Unfortunately, the carriage may protrude into the upper and lower landing areas of the staircase, interfering with traffic through those areas.

High ceiling homes may have as many as twenty-one stairs in a single flight, which can make it difficult to carry groceries or laundry up the stairs. Elevators may force the user to wait for arrival. Escalators may ruin the aesthetics of a home.

### SUMMARY

Embodiments of a staircase system are described below that assist the user in moving up or down the staircase. The staircase system may include a virtual platform that continuously moves along the staircase. The virtual platform may be created by progressively adjusting a sequential set of steps to a common elevation such that a user can walk forward across a level, unbroken platform while changing elevation.

In some implementations, the staircase system may dynamically change the elevation of selected steps to provide a flat platform surface comprised of two or more steps, which moves up the staircase as the user continues to walk. The steps that comprise the flat platform surface change in a first-in first-out sequence as the individual steps are raised to advance the user from a first level to a second level

Embodiments of systems, methods, and devices described herein including a plurality of steps that have independently controllable elevations to produce a temporary platform that ascends and descends to assist an individual in moving between floors. In some implementations, travel up or down the staircase is initiated by the individual approaching the staircase. A controller may automatically adjust elevations of one or more steps to form a platform to receive the individual, and may continue to adjust elevations of the one or more steps dynamically as the individual advances onto the platform, raising steps under the individual's feet while adjusting the elevation of a next step to extend the platform. In an example, a first step may remain at a first elevation, while an elevation of a second step may be adjusted to the first elevation, and an elevation of a third step may be adjusted to the first elevation. As the individual moves toward the second step, the elevations of the first step, the second step, and the third step may be adjusted to the second elevation, while an elevation of a fourth step may be adjusted to the second elevation, and so on. As the individual continues to move forward, the elevation of the first step may be adjusted to the first elevation, while the elevations of the second step, the third step, the fourth step, and a fifth step may be adjusted to a third elevation. The elevations of the steps may be adjusted sequentially to maintain a platform comprised of several steps at a common elevation to enable the individual to mount the staircase while moving along a flat surface, such that the temporary platform ascends or descends to carry the individual between floors.

In some embodiments, a stairway system may include a plurality of actuators and a staircase comprising a plurality of steps. Each step may be coupled to one or more actuators of the plurality of actuators. Each step may have an associated default elevation and may be movable between the associated default elevation and one or more second elevations based on movement of the one or more actuators. The stairway system may also include a control system configured to control each of the plurality of actuators independently to adjust two or more steps of the plurality of steps to share a selected elevation. The two or more steps may cooperate to form a temporary platform, which may be moved from a first floor to a second floor by selectively adjusting the elevations of the plurality of steps.

In other embodiments, a method may include determining a first position of a user relative to a first step of the plurality of steps based on a signal from a first sensor of the plurality of sensors. The method may further include determining elevations of at least some of the plurality of steps based on signals from position sensors of the plurality of sensors. The elevations may include a first elevation of a first step, a second elevation of a second step, a third elevation of a third step, and a fourth elevation of a fourth step. The method also includes moving the second step and the third step to the first elevation to form the temporary platform comprised of the first step, the second step and the third step. The method may also include determining a second position of the user relative to the temporary platform and moving the first step, the second step, the third step, and the fourth step to the second elevation to an elevation of the temporary platform from the first elevation to the second elevation.

In still other embodiments, a stairway system may include a staircase comprising a plurality of steps. Each step of the plurality of steps has an associated default elevation. At least some of the plurality of steps are adjustable from the associated default elevation to one or more other elevations. The stairway system may also include one or more actuators to adjust an elevation of selected steps of the plurality of steps and a control system configured to control the one or more actuators to adjust two or more steps of the plurality of steps to share a selected elevation to form a temporary platform and to adjust the selected elevation of the temporary platform.

In some embodiments, a stairway system may include a staircase comprising a plurality of steps, one or more actuators to adjust an elevation of selected steps of the plurality of steps, and a control system configured to control the one or more actuators. The control system may adjust two or more steps of the plurality of steps to share a selected elevation to form a temporary platform and to adjust the selected elevation of the temporary platform.

In other embodiments, a method may include detecting a user approaching a staircase comprising a plurality of steps and selectively controlling a subset of the plurality of steps to have a common elevation to form a virtual platform. The method may further include controlling elevations of each of the plurality of steps to move the virtual platform to carry the user from a first level to a second level along the staircase.

In still another embodiment, a stairway system may include a plurality of actuators and a staircase comprising a plurality of steps. At least some of the plurality of steps may be responsive to one or more of the plurality of actuators to be adjustable in elevation to form a virtual platform.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 is a perspective view of a staircase system including a vertically adjustable steps to provide a temporary platform, in accordance with certain embodiments.

FIG. 2 depicts a sequence of side views of a staircase system as the temporary platform advances from a first floor to a second floor, in accordance with certain embodiments.

FIG. 3 depicts a perspective view of the staircase system with the temporary platform at the second-floor level, in accordance with certain embodiments.

FIG. 4 depicts a side view of a portion of the staircase system including actuators to move each step of the staircase system independently, in accordance with certain embodiments.

FIG. 5 depicts a front view of a portion of a step of the staircase system including guides or rails and one or more actuators, in accordance with certain embodiments.

FIG. 6 depicts a block diagram of a system to control the steps of the staircase system, in accordance with certain embodiments.

FIG. 7 depicts a side view of a staircase system including a trolley system for selectively elevating steps, in accordance with certain embodiments.

FIG. 8 depicts a flow diagram of a method of providing a temporary platform by moving vertically adjustable steps, in accordance with certain embodiments.

While implementations are described in this disclosure by way of example, those skilled in the art will recognize that the implementations are not limited to the examples or figures described. It should be understood that the figures and detailed description thereto are not intended to limit implementations to the particular form disclosed but, on the contrary, the intention is to cover all modifications, equivalents, and alternatives falling within the spirit and scope as defined by the appended claims. The headings used in this disclosure are for organizational purposes only and are not meant to be used to limit the scope of the description or the claims. As used throughout this application, the word “may” is used in a permissive sense (i.e., meaning having the potential to) rather than the mandatory sense (i.e., meaning must). Similarly, the words “include”, “including”, and “includes” mean “including, but not limited to”.

### DETAILED DESCRIPTION OF ILLUSTRATIVE EMBODIMENTS

Embodiments of stairway systems, methods, and devices are described below that may be used to transport users between floors of a building. In an example, the stairway system includes steps that can be controlled independently of one another to move vertically at least two elevations (step levels). The steps may be controlled to provide a virtual platform comprised of two or more steps that share the same elevation to present a flat surface. As the user steps onto the platform, the steps of the virtual platform and adjacent steps may be moved to extend the platform in a direction of the user's movement and at the same time the steps may be raised vertically. Thus, as the user moves horizontally along the platform, the platform moves vertically to move the user from a first floor to a second floor. In some implementations, the virtual platform is comprised of enough steps to allow a user with a walker to walk on the platform with the walker. In other implementations, the virtual platform is comprised of several steps to carry a wheelchair. Other implementations are also possible.

In some embodiments, a stairway system may include a staircase comprising a plurality of steps. The elevations or heights of at least some of the steps may be adjusted dynamically to create a virtual platform formed from a subset of the steps. A control system may control selected steps to move the virtual platform continuously from a first level to a second level. In some implementations, the virtual platform may move vertically at a predetermined rate. In other implementations, the virtual platform may move at rate that is proportional to the lateral movement of a user. Other implementations are also possible.

In other embodiments, a method may include detecting a user approaching a staircase comprising a plurality of steps and selectively controlling a subset of the plurality of steps to have a common elevation to form a virtual platform. The method may further include controlling elevations of each of the plurality of steps to move the virtual platform to carry the user from a first level to a second level along the staircase. The rate of vertical movement of the virtual platform may be proportional to the rate of lateral movement of the user.

In still another embodiment, a stairway system may include a plurality of actuators and a staircase comprising a plurality of steps. At least some of the plurality of steps may be responsive to one or more of the plurality of actuators to be adjustable in elevation to form a virtual platform.

The stairway system may include a plurality of steps, a plurality of actuators, and a control system configured to control each of the plurality of actuators independently to move selected steps vertically. In some implementations, the control system may move selected steps up and down to align a top surface of each of the selected steps to present a platform for supporting a user. As the user moves onto the platform, the control system may actuate at least some of the steps forming the platform to move from a first elevation to a second elevation and may actuate a next step to move from a default elevation to the second elevation to extend the platform. As the user continues to move, a next may be moved into alignment with the platform while a last step may be returned to its default elevation in a first-in first-out sequence. In this implementation, each step may be movable vertically independent of other steps, allowing the platform to be formed dynamically as the user moves,

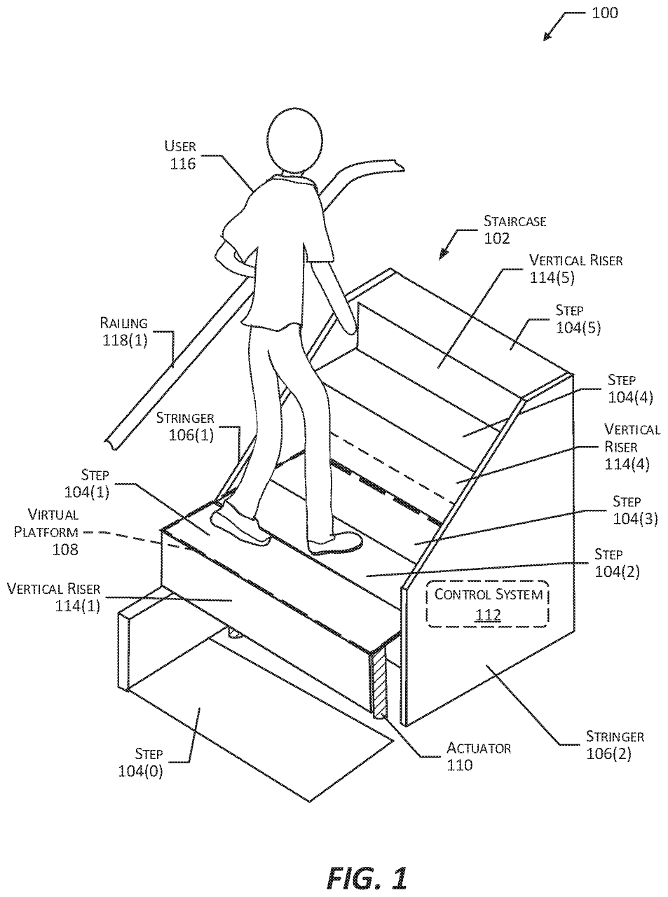

FIG. 1 is a perspective view of a staircase system 100 including a staircase 102 and including vertically adjustable steps 104 to provide a temporary or virtual platform 108, in accordance with certain embodiments. Each step 104 may include a vertical riser 114. The step 104 may be secured between stringers 106(1) and 106(2). The staircase system 100 may also include a plurality of actuators 110, at least one of which may be positioned under each step and hidden by the vertical riser 114. The actuators 110 may be controlled by electrical signals provided by a control system 112, which may be positioned under the staircase 102. In an alternative embodiment, the control system 112 may be at another location but may be in communication with the actuators 110 and optionally one or more sensors associated with the staircase 102. In some implementations, the staircase system 100 may further include railings 118, such as the railing 118(1).

In operation, as the user 116 walks toward the staircase 102, the control system 112 may detect the user's approach and may adjust the elevations of two or three of the steps 104 to establish the virtual platform 108. In the illustrated example, the user is moving up the staircase 102. Thus, the steps 104(1) and 104(2) may be lowered to provide a planar surface together with the step 104(0). Once the user 116 advances (walks or rolls) onto the virtual platform 108, the control system 112 may raise the steps 104(0), 104(1), and 104(2) to a second elevation and lower the step 104(3) to the second elevation. Once a top surface of the step 104(3) is aligned with the surfaces of the steps 104(1) and 104(2), the step 104(0) may return to its default elevation. The virtual platform 108 represents this configuration. The virtual platform 108 includes steps 104(1), 104(2), and 104(3).

As the user continues to advance, the control system 112 may raise steps 104(1), 104(2), and 104(3) to a next elevation, and may lower step 104(4) to the next elevation to extend the virtual platform 108. The step 104(1) may then be returned to its default position as a next step, step 104(5) may begin moving toward the selected elevation. The process may be repeated with adjacent steps until the virtual platform 108 reaches its final elevation. In some implementations, the railings 118 may also move with the steps 104, providing support for the user 116 as the virtual platform 108 moves.

In the illustrated example, a single user 116 is moving up the staircase 102 on the virtual platform 108. The steps 104 may be moved vertically, such that the virtual platform 108 moves vertically at a rate that is proportional to a rate of lateral movement of the user 116. If the user stops, the virtual platform 108 may also stop. In other embodiments, the control system 112 may advance the virtual platform 108 according to a predetermined timing. In some implementations, once the virtual platform 108 begins moving, the virtual platform 108 may move continuously from a first level to a second level. Other implementations are also possible.

While only one user 116 is shown, the staircase system 100 may be configured to provide a second virtual platform 108 at either end of the staircase 102. In some implementations, a first user 116(1) may move from a first level to a second level, while a second user 116(2) may move from a second level to a first level. The virtual platforms 108 may temporarily overlap as the users pass one another. Other implementations are also possible.

The staircase system 100 provides several advantages over conventional assisted movement systems, such as escalators, elevators, and the like. First, because each step 104 may be adjusted independently, the amount of power needed to move the step 104 is much smaller than the amount of power needed to move a carriage (such as an elevator). Additionally, the steps 104 may be moved independently, making it possible to have multiple virtual platforms 108 concurrently, moving in the same direction or in opposite directions. Thus, a user need not wait for the carriage to return to a starting position to make use of the virtual platform. In some implementations, a further advantage may be realized in that the staircase system 100 may be implemented as a spiral staircase or in other form factors, depending on the implementation.

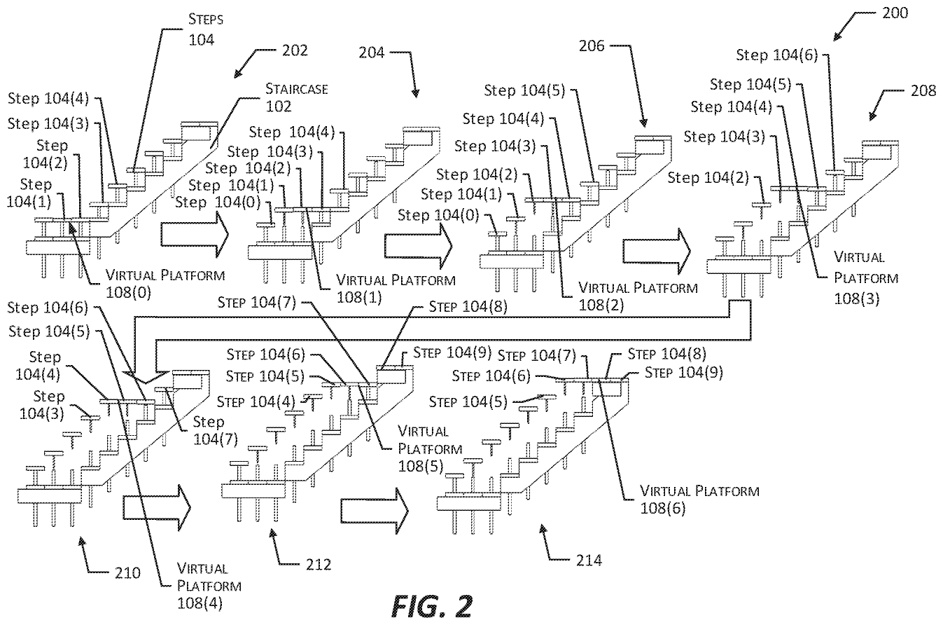

FIG. 2 depicts a sequence 200 of side views of the staircase system 100 as the temporary or virtual platform 108 advances from a first floor to a second floor, in accordance with certain embodiments. At 202, the staircase 102 include multiple steps 202 including the first step 104(0), the second step 104(1), and the third step 104(2) of the staircase 102 arranged to form the virtual platform 108(0) at a first elevation.

At 204, the second step 104(1), the third step 104(2), and the fourth step 104(3) are configured to form a virtual platform 108(1) at a second elevation. The first step 104(0) may move with the second step 104(1) until the fourth step 104(3) is aligned with the third step 104(3), and then the first step 104(0) may return to its default elevation or to an intermediate elevation.

At 206, the second step 104(1) has returned to its default position, and the third step 104(2), the fourth step 104(3), and the fifth step 104(4) are aligned to form the virtual platform 108(2). The sixth step 104(5) may begin moving vertically toward the elevation of the virtual platform 108(2). Other steps 104 may be in their default positions or at selected elevations.

At 208, the third step 104(2) has returned to its default elevation. The fourth step 104(3), the fifth step 104(4), and the sixth step 104(5) form the virtual platform 108(3). The seventh step 104(6) may begin to move toward the virtual platform 108(3). The other steps 104 may be in their default positions or at selected elevations.

At 210, the fourth step 104(3) has returned to its default position. The fifth step 104(4), the sixth step 104(5), and the seventh step 104(6) are arranged to form the virtual platform 108(4). The eighth step 104(7) may return to a default elevation or may remain in a raised and locked elevation. The eighth step 104(7) may begin to move toward the virtual platform 108(4).

At 212, the fifth step 104(4) is at its default elevation or at a selected elevation. The sixth step 104(5), the seventh step 104(6), and the eight step 104(7) may be aligned to form the virtual platform 108(5) at a selected elevation. The ninth step 104(8) may remain at a default elevation or at a selected elevation.

At 214, the seventh step 104(6), the eighth step 104(7), the ninth step 104(8), and the step 104(9) may form the virtual platform 108(6) at the second-floor level. The sixth step 104(5) may remain locked at an elevation.

As can be seen from the progression of the virtual platform 108 from 212 through 214, the elevations of each of the steps may be adjusted dynamically to advance the user 116 from the first floor to the second floor. The progression may be reversed to carry the user 116 from the second floor to the first floor. The individual steps 104 move vertically to align with adjacent steps 104 to form the virtual platform 108. The user 116 may continue to move forward along the flat surface provided by the virtual platform 108 as the steps 104 move to adjust the elevation of the virtual platform 108. Thus, the user 116 may continue to walk along a flat surface while the steps 104 move to carry the user up or down the staircase 102.

In some implementations, the stringer 106 of the staircase 102 may be extended vertically and may provide a mounting surface for a rail or guide that may engage a roller or slide to secure the step 104 as it is moved vertically by the actuator 110 so that the step 104 does not shift laterally as the actuator 110 adjusts the elevation of the step 104. Other implementations are also possible.

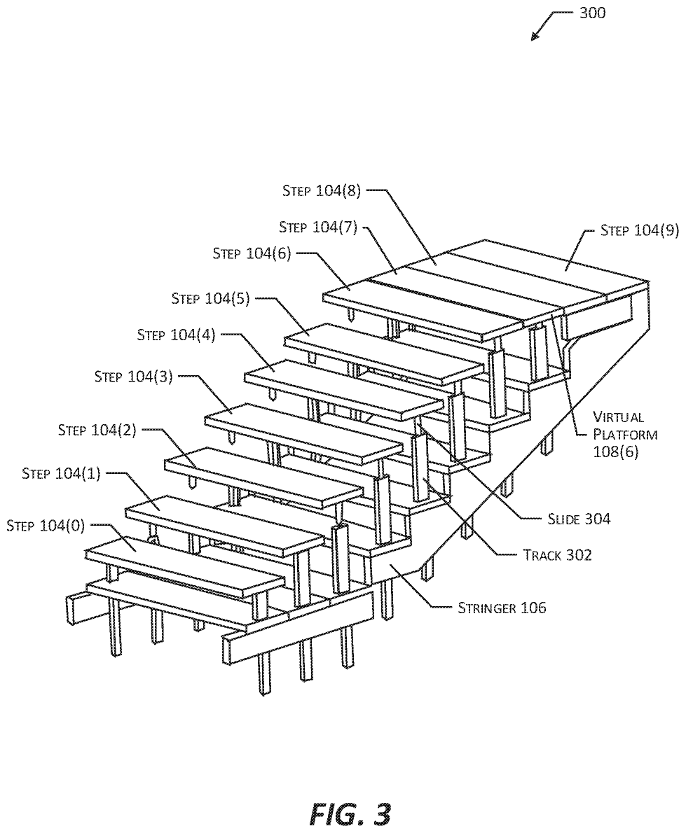

FIG. 3 depicts a perspective view 300 of the staircase system 100 with the temporary platform 108(6) at the second-floor level, in accordance with certain embodiments. The perspective view 300 depicts the steps 104(0), 104(1), 104(2), 104(3), 104(4), 104(5), 104(6), and 104(7) include slides 304 to engage corresponding tracks 302. The rails 302 may extend for a distance corresponding to the elevation range of the associated step 104. Further, the stringer 106 may extend vertically to provide a mounting surface for the rail 302.

In the illustrated example, the track 302 is depicted as extending to the step 104; however, in other implementations, the track 302 may extend to a lowest elevation that a step 104 may move to and the slide 304 may extend into the track 302. The slide 304 may be sufficiently long to fit into the rail 302 at the further extent of the vertical movement of the step 104.

In the illustrated example, the slide 304 may engage the track 302 and may move up and down within or on the track 302, allowing the corresponding step 104 to move vertically. The track 302 engages the slide 304 and restrains lateral movement of the step 104, stabilizing the step 104 when it is moving or when it is stationary.

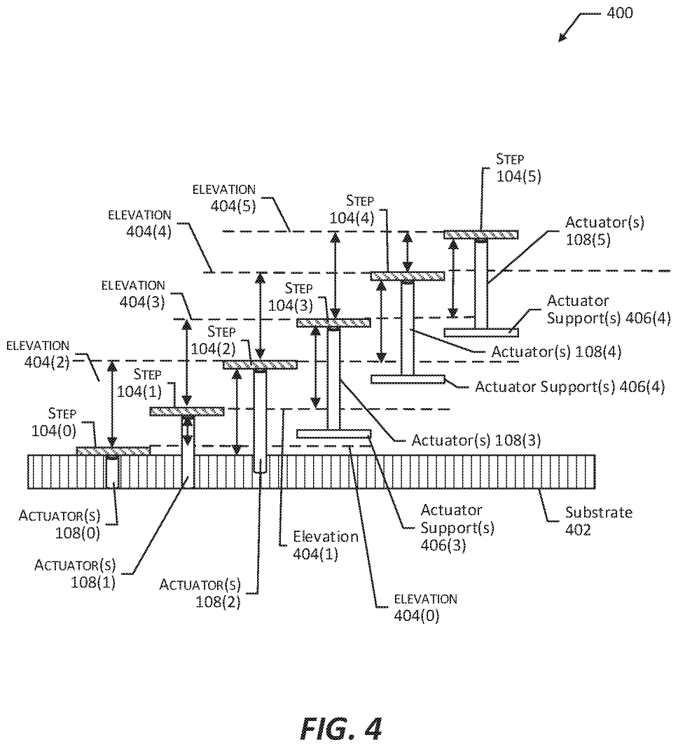

FIG. 4 depicts a side view of a portion 400 of the staircase system 100 including actuators 108 to move each step 104 of the staircase 102 independently, in accordance with certain embodiments. In this example, each of the steps 104 is coupled to one or more actuators 108, which are positioned beneath the step 104. The one or more actuators 108 may operate to alter an elevation of a step 104.

The staircase system 100 may include a first step 104(0) coupled to one or more actuators 108(0), which may be recessed into a substrate 402, such as the floor. The one or more actuators 108(0) may raise the step 104(0) from a first elevation 404(0) to a second elevation 404(1) and optionally to a third elevation 404(2).

The staircase system 100 may include a second step 104(1) coupled to one or more actuators 108(1), which may be recessed into the substrate 402. The one or more actuators 108(1) may move the second step 104(1) from between a first elevation 404(0), a second elevation 404(1), and a third elevation 404(2). The second elevation 404(2) may be a default elevation for the second step 104(1).

The staircase system 100 may include a third step 104(2) coupled to one or more actuators 108(2), which may be recessed into the substrate 402. The one or more actuators 108(2) may move the third step 104(2) from between a first elevation 404(0), a second elevation 404(1), a third elevation 404(2), a fourth elevation 404(3), and a fifth elevation 404(4). The third elevation 404(2) may be a default elevation for the second step 104(1).

The staircase system 100 may include a fourth step 104(3) coupled to one or more actuators 108(3), which may be supported by an actuator support 406(3). The actuator support 406(3) may be elevated above the substrate 402. The one or more actuators 108(3) may move the fourth step 104(3) from between a second elevation 404(1), a third elevation 404(2), a fourth elevation 404(3), a fifth elevation 404(4), and a sixth elevation 404(5). The fourth elevation 404(3) may be a default elevation for the fourth step 104(3).

The staircase system 100 may include a fifth step 104(4) coupled to one or more actuators 108(4), which may be supported by an actuator support 406(4). The actuator support 406(4) may be elevated above the substrate 402. The one or more actuators 108(4) may move the fifth step 104(4) from between a third elevation 404(2), a fourth elevation 404(3), a fifth elevation 404(4), and a sixth elevation 404(5). The fifth elevation 404(4) may be a default elevation for the fifth step 104(4).

The staircase system 100 may include a fifth step 104(4) coupled to one or more actuators 108(4), which may be supported by an actuator support 406(4). The actuator support 406(4) may be elevated above the substrate 402. The one or more actuators 108(4) may move the fifth step 104(4) from between a third elevation 404(2), a fourth elevation 404(3), a fifth elevation 404(4), and a sixth elevation 404(5). The fifth elevation 404(4) may be a default elevation for the fifth step 104(4).

The staircase system 100 may include a sixth step 104(5) coupled to one or more actuators 108(5), which may be supported by an actuator support 406(5). The actuator support 406(5) may be elevated above the substrate 402. The one or more actuators 108(5) may move the sixth step 104(5) from between a fourth elevation 404(3), a fifth elevation 404(4), a sixth elevation 404(4). The sixth elevation 404(5) may be a default elevation for the sixth step 104(5).

While in this example, some of the steps, such as the third step 104(2) may be moved between five different elevations 404, in other implementations, the steps 104 may be moved between three elevations 404. Further, it should be appreciated that the steps 104 may transition between elevations 404. The elevations 404(0) through 404(5) are provide for illustrative purposes only, and the one or more actuators 108 may move the steps 104 to a selected elevation, which may correspond to one of the illustrative elevations 404(0) through 404(5) or to another intermediate elevation. Other implementations are also possible.

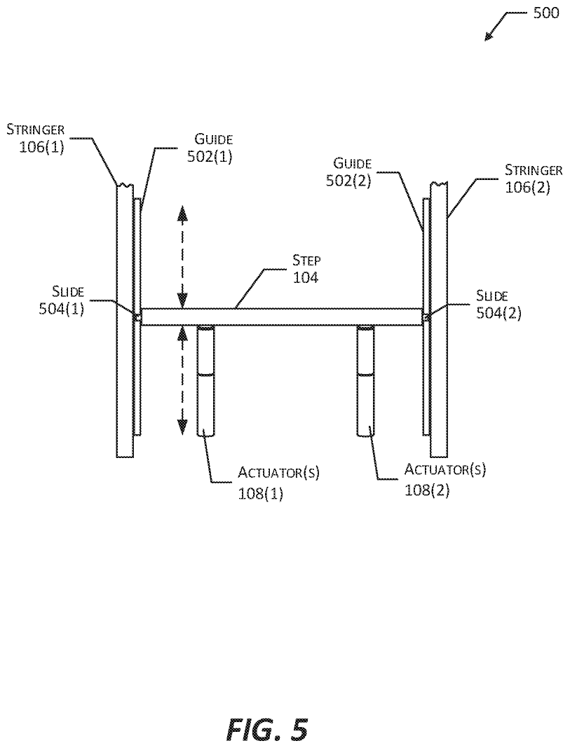

FIG. 5 depicts a front view 500 of a portion of a step 104 of the staircase system 102 including guides or rails 502 and actuators 108, in accordance with certain embodiments. The guides 502 may be coupled to the stringers 106. The step 104 may include slides 504 mounted to each end and configured to engage the guides 502. A first guide 502(1) may be coupled to the first stringer 106(1), and a second guide 502(2) may be coupled to the stringer 106(2). The step 104 may include a first slide 504(1) coupled to a first end and configured to couple to the guide 502(1), and a second slide 504(2) coupled to a second end and configured to couple to the guide 502(2).

In this example, the slide 504 may engage the guide 502 to slide up and down along the guide 502. The guide 502 and the slide 504 may be coupled so that the step 104 is restrained from moving laterally. The actuators 108 may move the step 104 up and down.

In some implementations, the actuators 108 may be implemented in a variety of ways. The actuator 108 may be hydraulic, pneumatic, or electric. Implemented as a hydraulic actuator, the actuator 108 may include a cylinder or fluid motor that utilizes liquid pressure to facilitate mechanical movement of the step 104. Implemented as a pneumatic actuator, the actuator 108 may use compressed gas instead of liquid. Implemented as an electrical actuator, the actuator 108 may include a motor that converts electrical energy into mechanical torque to lift the step 104. Other implementations are also possible.

In the illustrated example, the steps 104 may be moved vertically, such that the virtual platform 108 moves vertically at a rate that is proportional to a rate of lateral movement of the user 116. If the user stops, the virtual platform 108 may also stop. In other embodiments, the control system 112 may advance the virtual platform 108 according to a predetermined timing. In some implementations, once the virtual platform 108 begins moving, the virtual platform 108 may move continuously from a first level to a second level. Other implementations are also possible.

While only one user 116 is shown, the staircase system 100 may be configured to provide a second virtual platform 108 at either end of the staircase 102. In some implementations, a first user 116(1) may move from a first level to a second level, while a second user 116(2) may move from a second level to a first level. The virtual platforms 108 may temporarily overlap as the users pass one another. Other implementations are also possible.

The staircase system 100 provides several advantages over conventional assisted movement systems, such as escalators, elevators, and the like. First, because each step 104 may be adjusted independently, the amount of power needed to move the step 104 is much smaller than the amount of power needed to move a carriage (such as an elevator). Additionally, the steps 104 may be moved independently, making it possible to have multiple virtual platforms 108 concurrently, moving in the same direction or in opposite directions. Thus, a user need not wait for the carriage to return to a starting position to make use of the virtual platform. In some implementations, a further advantage may be realized in that the staircase system 100 may be implemented as a spiral staircase or in other form factors, depending on the implementation.

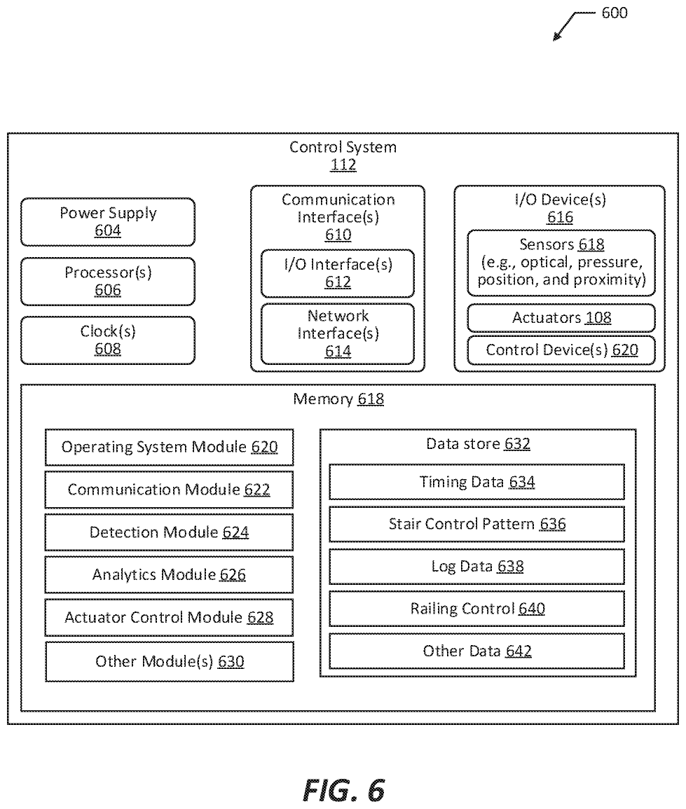

FIG. 6 depicts a block diagram of a system 600 to control the steps 104 of the staircase system 102, in accordance with certain embodiments. The system 600 may be an embodiment of the control system 112 of FIG. 1. The control system 112 may be implemented as a computing device, such as a personal computer, or a special purpose device. In some implementations, the control system 112 can be implemented as a field-programmable gate array (FPGA) or other circuit configured to control the elevations 404 of the steps 104.

The control system 112 may include one or more power supplies 604 to provide electrical power suitable for operating the components of the control system 112. In some implementations, the power supply 604 may include a rechargeable battery, fuel cell, photovoltaic cell, power conditioning circuitry, and so forth.

The control system 112 may include one or more hardware processor(s) 606 (processors) configured to execute one or more stored instructions. The processor(s) 606 may include one or more cores. One or more clocks 608 may provide information indicative of date, time, ticks, and so forth. For example, the processor(s) 606 may use data from the clock 608 to generate a timestamp, trigger a preprogrammed action, and so forth.

The control system 112 may include one or more communication interface(s) 610, such as input/output (I/O) interface(s) 612, network interface(s) 614, and so forth. The communication interfaces 610 may enable the control system 112, or components of the control system 112, to communicate with other computing devices 602 or components thereof. The I/O interface(s) 612 may include interfaces such as Inter-Integrated Circuit (I2C), Serial Peripheral Interface bus (SPI), Universal Serial Bus (USB) as promulgated by the USB Implementers Forum, RS-232, and so forth.

The I/O interface(s) 612 may couple to one or more I/O device(s) 616. The I/O devices 616 may include any manner of input device or output device associated with the control system 112. For example, I/O devices 616 may include input devices, such as touch sensors, keyboards, pointer devices, microphones, sensors 618 (optical, pressure, position, motion, location, and so on), control devices 620, other input devices, and so forth. The I/O devices 616 may also include output devices such as displays, speakers, lights, haptic devices, actuators 108, other output device, or any combination thereof. In some implementations, the I/O device(s) 616 may be physically incorporated with the control system 112 or may be externally placed.

The one or more network interface 614 may be configured to provide communications between the control system 112 and other devices, such as smartphone, a tablet computer, or another computing device, such as through a Bluetooth® connection. Alternatively, or in addition, the network interface(s) may communicate with routers, access points, other computing devices, and so forth. The one or more network interface 614 may include transceivers configured to couple to one or more networks, including local area networks (LANs), wireless LANs, wide area networks (WANs), wireless WANs, and so forth. For example, the network interfaces 614 may include transceivers compatible with Ethernet, Wi-Fi, Wi-Fi Direct, Bluetooth, Bluetooth Low Energy, ZigBee, Z-Wave, 3G, 4G, 5G, LTE, and so forth.

The control system 112 may include one or more busses or other internal communications hardware or software that allows for the transfer of data between the various modules and components. The control system 112 may also include one or more memories 618. The memory 618 may include one or more computer-readable storage device (CRSD). The CRSD may be any one or more of an electronic storage device, a magnetic storage device, an optical storage device, a quantum storage device, other memory devices, or any combination thereof. The memory 618 may store computer-readable instructions, data structures, program modules, and other data for the operation of the control system 112. A few example modules are shown stored in the memory 618, although the same functionality may alternatively be implemented in hardware, firmware, or as a system on a chip (SoC).

The memory 618 may include one or more operating system (OS) modules 620. The OS module 620 may be configured to manage hardware resource devices such as the I/O interfaces 612, the network interfaces 614, the I/O devices 616, and to provide various services to applications or modules executing on the processors 606. The OS module 620 may implement any number of operating systems.

The memory 618 may store one or more modules. The modules may be executed as foreground applications, background tasks, daemons, and so forth. The memory 618 may include a communication module 622 configured to control the communications interfaces 610 to establish communications with I/O devices 616 or other computing devices. For example, the communication module 622 may be configured to receive signals from the I/O devices 616 via the I/O interfaces 612 and to process the received signals. Further, the communication module 622 may provide control signals to control the one or more actuators 108.

The memory 618 may include a detection module 624 that cooperates with the sensors 618 to determine proximity of a user 116 to the staircase 102, to determine pressure on one or more of the steps 104, to determine a position of each of the steps 104, and so on. In some implementations, the detection module 624 may provide detection signals that may be used control timing of movement of the steps 104 by an actuator control module 628. For example, the actuator control module 628 may provide control signals to the actuators 108 to control vertical movement of the steps 104 independently of one another. However, if the detection module 624 determines that a user is applying pressure to two or more steps 104, the actuator control module 628 may selectively control movement of the steps 104 to avoid moving the two steps in toward different elevations 404. Other implementations are also possible.

The memory 618 may also include analytics module 626 that may cause the processor 606 to determine a rate of movement of the user 116 and to control timing of the movement of the steps 104 by communicating with the actuator control module 628. The analytics module 626 may determine the timing of when to cause the actuators 108 to move the steps 104 to provide, maintain, and move the virtual platform 108. The memory 618 may also include other modules 630, which may cause the processor 606 to perform other operations.

The memory 618 may also include a data store 632. The data store 632 may use a flat file, database, linked list, tree, executable code, script, or other data structure to store information. In some implementations, the data store 632 or a portion of the data store 632 may be distributed across one or more other devices including other computing devices, network attached storage devices, and the like.

The data store 632 may include timing data 634, including data determined from the analytics module 626. The timing data 634 may include data related to timing of movement of the steps 104, such as an amount of time needed to move a step 104 from one elevation 404 to another. Additionally, the timing data 634 may include information related to movement of a user 116, including timing of changes in pressure or changes in position of the user 116 over time.

The data store 632 may also include a stair control pattern 636, which may define a width of the virtual platform 108, as well as the pattern of movement of the various steps to establish and maintain the virtual platform. Other implementations are also possible.\

The data store 632 may include log data 638, including information about previous step movements, timing, and other information, as well as user feedback. In some implementations, a user may provide feedback with respect to timing by interacting within an I/O device 616 or by interacting with an interface of a smartphone or other device.

In some implementations, the data store 632 may include railing control instructions 640 that, when executed, may cause the processor 608 to control movement of the railing 118, so that the railing moves together with the steps. In some implementations, the railing may include multiple segments, each of which may be movable in conjunction with movement of an actuator 110. The data store 632 may also include other data 642. Other implementations are also possible.

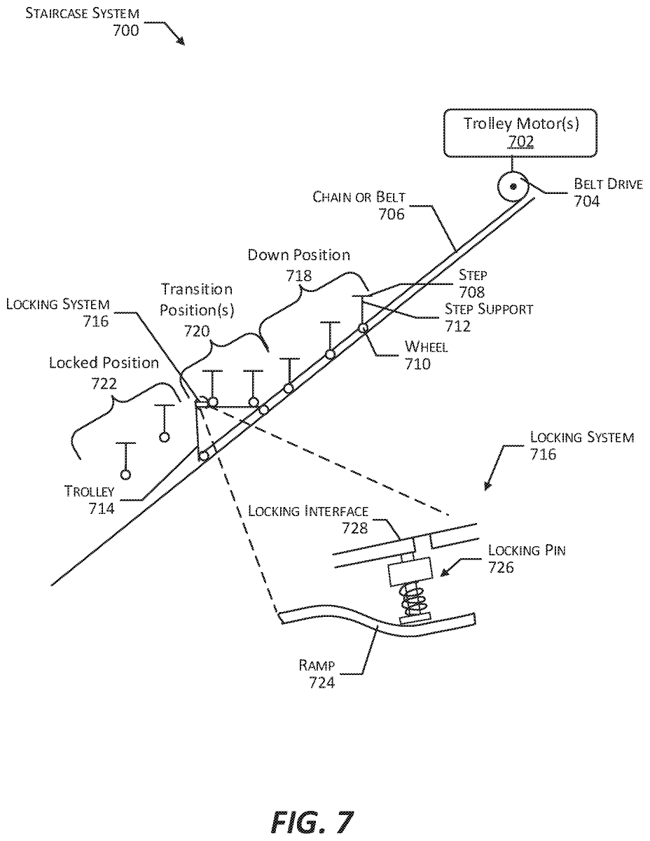

FIG. 7 depicts a side view of a staircase system 700 including a trolley system for selectively elevating steps, in accordance with certain embodiments. In this example, the trolley system may include one or more trolley motors 702 coupled to a belt drive 704 configured to move a belt or chain 706, which may be coupled to a trolley 714. The trolley 714 may present a ramp with a locking system 716. The belt or chain 706 may move the trolley 714.

In this example, the staircase system 700 may include a plurality of steps 708, each of which may include one or more step supports 712 coupled to a respective one or more wheels 710. As the trolley 714 moves under each step 708, the one or more wheels 710 may advance onto the ramp portion of the trolley 714, and the trolley 714 may raise the step 708 from a first elevation to a second elevation where it is locked into place by a locking system 716.

In the illustrated example, some of the steps 708 are in a down or default position 718. The steps 708 that are in contact with the trolley 714 are in transition or intermediate positions 720, and the steps 708 that have already been moved by the trolley 714 may remain in a locked or raised position 722.

The locking system 716 may include a ramp 724 of the trolley 714 to advance a locking pin 726 toward a locking interface 728. As the trolley 714 advances, the trolley 714 pushes the steps 708 up, and the ramp 724 pushes the locking pin 726 into the locking interface 728 once the step 708 reaches its second elevation 404.

When the trolley 710 moves in one direction, the steps 708 are raised and locked. When the trolley 710 moves in the other direction, the steps 708 are disengaged from their locked position and are lowered by the trolley 710 to their default elevation. Other implementations are also possible.

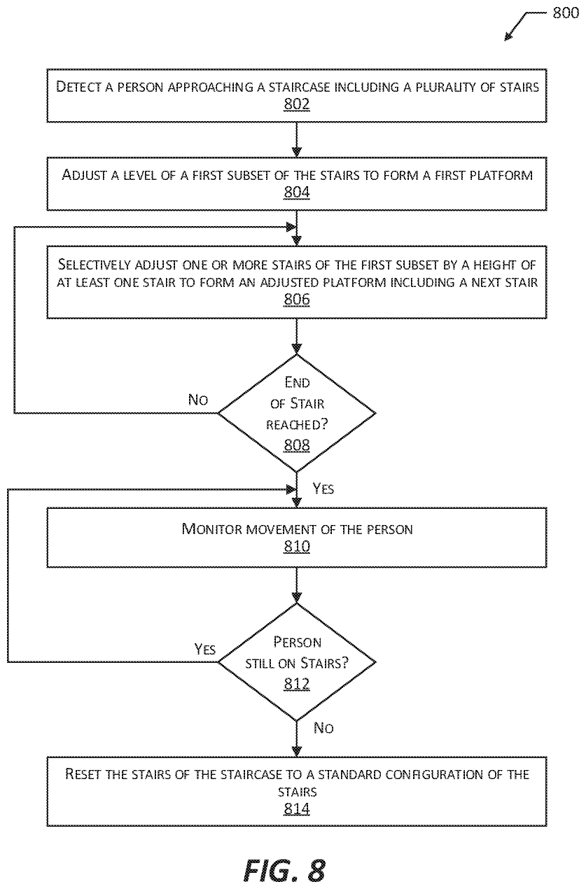

FIG. 8 depicts a flow diagram 800 of a method of providing a temporary platform by moving vertically adjustable steps, in accordance with certain embodiments. The method may be performed using any of the systems of FIGS. 1-7.

At 802, a person is detected approaching the staircase 102 that includes a plurality of stairs. The person may be detected using optical sensors, pressure sensors, proximity sensors, or any combination thereof. Changes in the detection signals over time may be used to determine the person or user 116 is approaching the staircase 102.

At 804, a level of a first subset of the stairs is adjusted to form a first platform. In one example, one or more actuators 108 may be controlled to adjust an elevation of the first subset of the steps 104. In another example, the trolley 714 may be moved to adjust the elevation 404 of one or more of the steps 708. Other implementations are also possible.

At 806, one or more of the stairs of the first subset may be selectively adjusted by a height of at least one stair to form an adjusted platform including a next stair. For example, a fifth step 104(4) may be moved to a fourth elevation 404(3).

At 808, if the end of the stair is not reached, the method may return to 806. At 806, one or more of the stairs of the first subset may be selectively adjusted by a height of at least one stair to form an adjusted platform including a next stair.

Otherwise, at 808, if the end of the stair is reached 808, the movement of the person may be monitored at 810. For example, the user 116 may begin moving off the virtual platform 108. The system may monitor the user 116 by monitoring sensor signals from one or more of an optical sensor, a pressure sensor, and a proximity sensor.

At 812, if the person is still on the stairs, the system may continue to monitor movement of the person at 810. Otherwise, at 812, the system may reset the stairs of the staircase to a standard configuration of the stairs. In an example, the system may reset each step 104 to a default elevation 404.

In conjunction with the systems, methods, and devices described above, a stairway system may include a staircase having a plurality of steps and including a plurality of actuators. Each step may be coupled to one or more actuators and may be configured to move vertically in coordination with one or more other steps to provide a virtual platform to carry a user from a first elevation to a second elevation as the user moves. In one implementation, the plurality of actuators may include electrical actuators, pneumatic actuators, hydraulic actuators, or any combination thereof. In another implementation, the plurality of actuators may include a trolley system including a trolley motor configured to move a chain or belt, which may be configured to move a trolley up or down the staircase to move the steps. Other implementations are also possible.

Although the present invention has been described with reference to preferred embodiments, workers skilled in the art will recognize that changes may be made in form and detail without departing from the scope of the invention.

1. A stairway system comprising:
a staircase comprising a plurality of steps;
one or more actuators to adjust an elevation of selected steps of the plurality of steps; and
a control system configured to control the one or more actuators to adjust two or more steps of the plurality of steps to share a selected elevation with one or more additional steps to form a temporary platform and to adjust the selected elevation of the temporary platform.

2. The stairway system of claim 1, wherein the one or more actuators comprises:
a first actuator coupled to a first step of the plurality of steps; and
a second actuator coupled to a second step of the plurality of steps.

3. The stairway system of claim 1, wherein the one or more actuators comprise one or more of hydraulic actuators, linear actuators, and electric actuators.

4. The stairway system of claim 1, wherein the control system controls the temporary platform to move from a first level to a second level at a constant rate according to a timer.

5. The stairway system of claim 1, wherein the control system:
determines movement approaching or on the staircase;
determines a lateral velocity from the movement and controls the temporary platform to move from a first level to a second level at a rate corresponding to the lateral velocity.

6. The stairway system of claim 1, wherein the control system includes a plurality of position sensors, each position sensor associated with a step of the plurality of steps and configured to produce an electrical signal proportional to a position of the step.

7. The stairway system of claim 1, wherein the control system includes at least one of an optical sensor and a pressure sensor to determine one or more of movement or a position relative to the plurality of steps.

8. The stairway system of claim 1, wherein the one or more actuators comprises a trolley coupled to one of a belt or a chain and configured to advance along a slope to move a subset of the plurality of steps from the default elevation to a second elevation.

9. The stairway system of claim 1, wherein the control system comprises:
a plurality of sensors;
a processor coupled to the plurality of sensors; and
a memory to store data and to store processor-executable instructions that cause the processor to:
determine a first signal from a first sensor of the plurality of sensors corresponding to a first step of the plurality of steps;
determine elevations of at least some of the plurality of steps based on signals from position sensors of the plurality of sensors, the elevations including a first elevation of a first step, a second elevation of a second step, a third elevation of a third step, and a fourth elevation of a fourth step;
adjust elevations of the second step and the third step to the first elevation to form the temporary platform comprised of the first step, the second step and the third step;
determine a second position of the user relative to the temporary platform; and
adjust the first step, the second step, the third step, and the fourth step to the second elevation to change an elevation of the temporary platform.

10. A method comprising:
determining movement approaching a staircase comprising a plurality of steps;
selectively controlling two or more of the plurality of steps to have a common elevation with one or more additional steps of the plurality of steps to form a virtual platform in response to the movement; and
controlling elevations of at least some of the plurality of steps to adjust an elevation of the virtual platform from a first level to a second level along the staircase.

11. The method of claim 10, wherein movement of the virtual platform is substantially continuous as the virtual platform moves from the first level to the second level.

12. The method of claim 10, further comprising:
determining a first signal from a first sensor of the plurality of sensors corresponding to a first step of the plurality of steps;
determining elevations of at least some of the plurality of steps based on signals from position sensors of the plurality of sensors, the elevations including a first elevation of a first step, a second elevation of a second step, a third elevation of a third step, and a fourth elevation of a fourth step;
moving the second step and the third step to the first elevation to form the virtual platform comprised of the first step, the second step and the third step;
monitoring signals from one or more of the plurality of sensors;
determining a lateral velocity based on the monitored signals; and
controlling a speed of vertical movement of the virtual platform relative to the lateral velocity.

13. The method of claim 12, wherein moving the first step, the second step, and the third step comprises:
simultaneously moving the first step, the second step, and the third step synchronously from the first elevation to the second elevation to move the virtual platform from the first elevation to the second elevation; and
moving the fourth step from the fourth elevation to the second elevation to extend the virtual platform.

14. The method of claim 10, wherein determining the movement comprises:
receiving a signal from one or more of a proximity sensor, an optical sensor, and a pressure sensor; and
determining the movement based on the received signal.

15. A stairway system comprising:
a plurality of actuators; and
a staircase comprising a plurality of steps, at least some of the plurality of steps responsive to one or more of the plurality of actuators to be adjustable in elevation; and
a control system configured to send signals to two or more actuators of the plurality of actuators to adjust elevations of two or more steps to share a selected elevation with one or more additional steps of the plurality of steps to form a virtual platform.

16. The stairway system of claim 15, further comprising the control system configured to selectively adjust elevations of selected ones of the plurality of steps to change the selected elevation of the virtual platform from a first level to a second level.

17. The stairway system of claim 15, further comprising:
one or more sensors to determine movement approaching the staircase;
determine a velocity from the movement; and
a control system to selectively adjust at least some of the plurality of steps to advance the virtual platform from a first level to a second level at a rate that is proportional to the velocity.

18. The stairway system of claim 15, wherein the plurality of actuators comprises one or more of a hydraulic actuator, a linear electric actuator, of a pneumatic actuator.

19. The stairway system of claim 15, wherein the control system includes a plurality of position sensors, each position sensor associated with a step of the plurality of steps and configured to produce an electrical signal proportional to a position of the step.

20. The stairway system of claim 15, wherein the control system includes at least one of an optical sensor or a pressure sensor to determine the movement relative to the plurality of steps.
